(19) United States
(12) Patent Application Publication
(10) Pub. No.: US 2007/0110102 A1
(43) Pub. Date: May 17, 2007

(54) Wireless multi-hop network, terminal and bandwidth ensured communication method for use therewith

(75) Inventors: Tomohiko Yagyuu, Tokyo (JP); Masahiro Jibiki, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/592,970

(22) Filed: Nov. 6, 2006

(30) Foreign Application Priority Data
Nov. 16, 2005 (JP) 2005-330951

(51) Int. Cl. H04J 3/16

(52) U.S. Cl. 370/470; 370/458

(57) ABSTRACT

To provide a wireless multi-hop network in which the stable bandwidth ensured communication can be made without causing a collision of time slots due to the terminal movement or reserving the slot again due to a route change on the path of end-to-end communication. A terminal makes a slot allocation request for 3 Hops to a slot allocation server. Since unique slots within the network are allocated by the slot allocation server, there is no interference with the slots by other terminals. The terminal transmits the packet by inserting the slot information into an option header. A forwarding terminal that forwards the packet decides the transmission slot based on the slot information in the option header and its own hop count at the time of forwarding the packet.

### BACKGROUND OF THE INVENTION

1. Field of the Invention

The present invention relates to a wireless multi-hop network, a terminal and a bandwidth ensured communication method for use therewith, and particularly to a bandwidth ensured communication method and a terminal for performing a packet forwarding via a mobile terminal as a relay node in a wireless multi-hop network controlled by a TDMA (Time Division Multiple Access) method.

2. Related Art

Conventionally, a wireless multi-hop network has been well known in which the terminals can communicate with each other by radio not only directly, but also via a relay node composed of another terminal existing within a radio communication range where the radio signal is reachable to enable transmission or reception of data between the terminals beyond the radio communication range.

This wireless multi-hop network consists of a plurality of terminals, and each terminal has a router function of forwarding the packet not addressed to itself. With this router function, each terminal can deliver the packet via another terminal to the destination terminal existing out of a radio communication range where the radio signal is reachable.

As a routing protocol for controlling the packet forwarding path autonomously and dispersely, a reactive type protocol for searching the path at the start of communication (e.g., refer to C. Perkins, E. Belding-Royer, and S. Das, “Ad hoc On-Demand Distance Vector (AODV) Routing”, IETF RFC3561, July 2003, David B. Johnson, David A. Maltz, and Yih-Chun Hu, “The Dynamic Source Routing Protocol for Mobile Ad Hoc Networks (DSR)”, IETF draft-ietf-manet-dsr-09.txt. April 2003) and a proactive type protocol for always maintaining the latest path by periodically exchanging the message with another terminal (e.g., refer to T. Clausen and one other, “Optimized Link State Routing Protocol (OLSR)”, IETF RFC 3626, October 2003, R. Ogier and two others, “Topology Dissemination Based on Reverse-Path Forwarding (TBRPF)”, IETF RFC3684, February 2004) are employed.

In the wireless network controlled by the TDMA method, a method for transmitting the packet preferentially by ensured bandwidth involves reserving slots in the communication with the adjacent terminal in a radio communication range (i.e., terminal existing within the radio communication range) (e.g., refer to Japanese Patent Publication No. 2793991, Japanese Patent Application Laid-Open No. 2004-186935, Zhenyu Tang et al., “A Protocol for Topology-Dependent Transmission Scheduling in Wireless Networks”, IEEE WCNC‘ 99 and Mahesh K. Marina et al., “RBRP: A Robust Broadcast Reservation Protocol for Mobile Ad Hoc Networks”, IEEE 2001 Globe com).

Also, there is a method for establishing a delay-controled path in the wireless multi-hop network in the TDMA (e.g., refer to National Publication of International No. 2005-504484). By combining this method and the above slot reservation method of the TDMA, the bandwidth ensured communication path can be established.

In the conventional bandwidth ensured communication method as above described, each terminal on the communication path reserves time slots not interfering with other terminals to forward the packet next to make the end-to-end (End-to-End) bandwidth reservation.

However, in the wireless multi-hop network, because each terminal moves autonomously, when other terminals using the same slot come closer, collision of the transmission in the slot causes to disable the communication with the conventional method for reserving the time slot with the adjacent terminal only.

Referring to FIG. 16, this instance will be described below. In FIG. 16, it is supposed that the communication from a terminal 1-1 to a terminal 1-4 and the communication from a terminal 2-1 to a terminal 2-4 are made. The forwardings of packet from the terminal 1-1 to the terminal 1-2, the terminal 1-2 to the terminal 1-3, and the terminal 1-3 to the terminal 1-4 are made employing time slots 2, 3 and 4, respectively. The forwardings of packet from the terminal 2-1 to the terminal 2-2, the terminal 2-2 to the terminal 2-3, and the terminal 2-3 to the terminal 2-4 are made employing time slots 1, 2 and 5, respectively.

At the time of starting the communication, the terminals 1-1 to 1-4 and the terminals 2-1 to 2-4 exist outside the range where the radio wave is reachable from one to another, and those slots are acquired by the conventional method. During the communication, the terminal 1-2 and the terminal 2-2 move in the directions coming close to each other as shown in FIG. 16. When the terminal 1-2 enters the radio transmission range of terminal 2-2, the terminal 1-2 receives the radio wave from the terminal 1-1 and that from the terminal 2-2 in the slot 2 at the same time, collision of the radio in the slot 2 causes to disable terminal 1-2 to receive data from terminal 1-1. In this condition, the communication at the terminal 1-2 can not recover the communication with terminal 1-2, until either the terminal 1-1 or the terminal 2-2 changes the using slot.

Also, in the wireless multi-hop network, the communication path is frequently changed. The control of the communication path (routing) is performed in accordance with the above routing protocol, but a time slot must again be reserved because a terminal to which a packet is forwarded is changed.

Referring to FIG. 17, this instance will be described below. In FIG. 17, the communication from the terminal 1-1 to the terminal 1-4 via the terminal 1-2 and the terminal 1-3 is made. Packets are forwarded from the terminal 1-1 to the terminal 1-2, the terminal 1-2 to the terminal 1-3, and the terminal 1-3 to the terminal 1-4 by using the time slots 2, 3 and 4, respectively. The path with these reserved slots is established by the method as described in the National Publication of International No. 2005-504484. These slots are acquired by the above conventional method.

As shown in FIG. 17, when the terminal 1-2 moves out of radio transmission ranges of the terminal 1-1 and the terminal 1-3, and the terminal 1-5 newly enters the ranges, the path from the terminal 1-1 to the terminal 1-4 is changed from the terminal 1-1 to the terminal 1-5 to the terminal 1-3 to the terminal 1-4 in accordance with the routing protocol. Since the slot 3 is reserved by the terminal 1-2, the terminal 1-5 becoming a new forwarding node can not employ the slot 3.

With the method as described in the National Publication of International No. 2005-504484, the reestablishment of the path and the corresponding slot reservation are required, whereby the communication can not recover until the path reestablishment and slot reservation complete. The conventional slot reservation method often fails and takes a lot of time, because it is dynamic. Therefore, the communication must stop for a long time or may break.

### BRIEF SUMMARY OF THE INVENTION

Thus, the present invention has been achieved to solve the above-mentioned problems, and the objective of the invention is to provide end-to-end communication in wireless multi-hop networks, a terminal and a bandwidth ensured communication method in which the stable bandwidth ensured communication can be made without collisions of time slots due to terminals movement and reallocation of slots due to change of routes.

A wireless multi-hop network of the invention comprises a plurality of terminals making the transmission, reception and forwarding of a packet by radio, wherein a source terminal transmits the packet by inserting reserved resource information into a header of the packet.

A terminal of the invention is a terminal in a wireless multi-hop network comprising a plurality of terminals making the transmission, reception and forwarding of a packet by radio, and comprises means for transmitting the packet by inserting reserved resource information into a header of the packet at the time of transmitting the packet.

A bandwidth ensured communication method of the invention is used in a wireless multi-hop network comprising a plurality of terminals making the transmission, reception and forwarding of a packet by radio, wherein the terminal performs a process of transmitting the packet by inserting reserved resource information into a header of the packet at the time of transmitting the packet.

That is, the wireless multi-hop network of the invention is controlled by the TDMA (Time Division Multiple Access), the time slot information reserved for transmitting the packet is stored in an option header of the packet, and the forwarding terminal transmits (forwards) the packet by using the time slot obtained from the information of the option header. Thereby, in the wireless multi-hop network of the invention, the stable and bandwidth ensured communication can be made from the source terminal to the destination terminal.

More specifically, to accomplish the above objective, the wireless multi-hop network of the invention comprises a plurality of terminals and one or more slot allocation servers, whereby a bandwidth ensured communication method is implemented.

Each of the terminals has the above bandwidth ensured communication method, and comprises an application program, a packet reception processing part, a packet forwarding processing part, a packet creation processing part, a packet transmission processing part, a packet scheduling processing part, a radio reception processing part, a radio transmission processing part, and a QoS (Quality of Service) setup processing part.

Also, each of the terminals comprises a slot request processing part for making a slot request based on a QoS setup request from the application program, and registering the flow information of the application (information consisting of the destination terminal and the information (port number, etc.) specifying the application) in a flow identification processing part, a flow identification processing part for identifying whether or not the transmit data created by the application program is the QoS set flow, an option header creation processing part for creating the option header storing the reserved slot information if the transmit data is the QoS set flow, a header creation processing part for creating the entire header including the option header, a forwarding destination terminal decision processing part for deciding the forwarding destination terminal based on the header information of the transmission packet created by the packet creation processing part or the forwarding packet received from the packet reception processing part, an option header analysis part for analyzing the option header to set the time slot for transmitting the packet to the packet scheduling processing part, and a transmission slot control processing part for making the scheduling control to transmit the packet in the set time slot.

The wireless multi-hop network of the invention employs a unique slot within the network that is allocated by the slot allocation server, whereby there is no interference with the slot by other terminals.

Also, in the wireless multi-hop network of the invention, the forwarding terminal decides the slot based on the option header information at the time of forwarding, whereby it is unnecessary that each terminal reserves a slot again as in the conventional method, even if the path is changed due to movement.

Accordingly, in the wireless multi-hop network of the invention, the stable, end-to-end bandwidth ensured communication in the wireless multi-hop network is allowed, though it could not be implemented by the conventional method, whereby the above-mentioned problems can be overcome.

That is, in the wireless multi-hop network of the invention, the terminal makes a slot allocation request for 3 Hops (triple the slots of required bandwidth) to the slot allocation server, and a unique slot within the network is allocated by the slot allocation server, whereby there is no interference with the slot by other terminals.

Next, the source terminal transmits the packet by inserting the slot information into the option header. The terminal that forwards the packet decides the transmission slot based on the slot information of the option header and its own hop count at the time of forwarding the packet. Therefore, in the wireless multi-hop network of the invention, it is unnecessary that each. terminal reserves a slot again as in the conventional method, even if the path (forwarding terminal) is changed due to movement, whereby the communication can be continued employing the secured slot.

Thereby, in the wireless multi-hop network of the invention, since the stable, end-to-end bandwidth ensured communication is allowed in the wireless multi-hop network, the stable bandwidth ensured communication can be made without causing a collision of time slots when the terminal moves or reserving the slot again due to a path change on the end-to-end communication in the wireless multi-hop network.

### BRIEF DESCRIPTION OF THE DRAWINGS

FIG. 1 is a block diagram showing the configuration of a wireless multi-hop network according to a first embodiment of the present invention;

FIG. 2 is a block diagram showing the functional configuration of a terminal according to the first embodiment of the invention;

FIG. 3 shows the organization of a TDMA frame for use in the first embodiment of the invention;

FIG. 4 shows the organization of an option header created in the first embodiment of the invention;

FIG. 5 shows the organization of the optional header passed to a header creation processing part of FIG. 2;

FIG. 6 shows the organization of a transmission packet created in the first embodiment of the invention;

FIG. 7 shows a flow table held in a flow identification processing part of FIG. 2;

FIG. 8 shows a slot information table held in an option header creation processing part of FIG. 2;

FIG. 9 shows the organization of a flow cache table in the first embodiment of the invention;

FIG. 10 shows the organization of a cache table in the first embodiment of the invention;

FIG. 11 is a diagram schematically showing a scheduling operation in the first embodiment of the invention;

FIG. 12 is a diagram showing a forwarding example of packet in a second embodiment of the invention;

FIG. 13 is a diagram showing a transmission interference example in a third embodiment of the invention;

FIG. 14 shows an option header example with increased “Hop CYCLE” in the third embodiment of the invention;

FIG. 15 shows a bandwidth ensured communication method according to a fourth embodiment of the invention;

FIG. 16 shows one example of problem with the conventional bandwidth ensured communication method; and

FIG. 17 shows another example of problem with the conventional bandwidth ensured communication method.

### DETAILED DESCRIPTION OF THE PREFERRED EMBODIMENTS

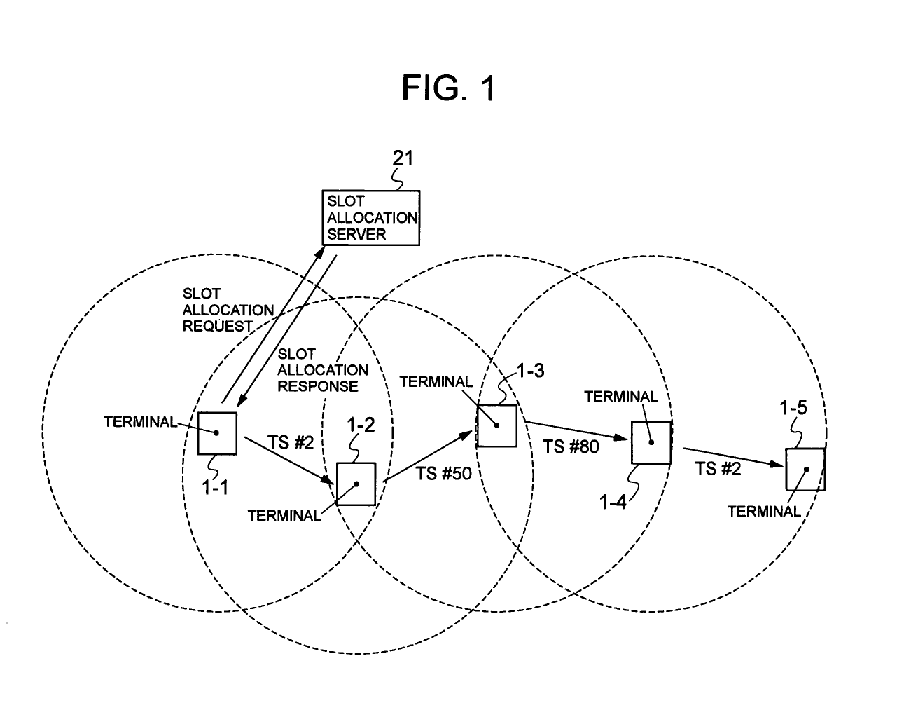

The preferred embodiments of the present invention will be described below with reference to the drawings. FIG. 1 is a block diagram showing the configuration of a wireless multi-hop network according to a first embodiment of the invention. In FIG. 1, the wireless multi-hop network according to the first embodiment of the invention comprises terminals 1-1 to 1-5, and a slot allocation server 21.

Each of the terminals 1-1 to 1-5 has two channels i.e., data channel and control channel, and performs a node on the wireless network in each channel. The wireless multi-hop network is formed by autonomously exchanging routing packets by radio among the terminals 1-1 to 1-5.

The media access for data channel on the wireless multi-hop network is controlled by a TDMA (Time Division Multiple Access), and the time slots are managed by the slot allocation server 21. When terminal 1-1 requests a slot allocation on the data channel to the slot allocation server 21, it transmits a slot allocation request packet to the slot allocation server 21, through the control channel controlled by a CSMA/CA (Carrier Sense Multiple Access with Collision Avoidance). The wireless multi-hop network is also formed on the control channel by certain routing protocol.

In this embodiment, one slot allocation server 21 is provided, but a plurality of slot allocation servers may exist within the wireless multi-hop network. Also, each of the terminals 1-1 to 1-5 is applicable to a portable telephone, a notebook PC (personal computer) or the vehicle.

Each of the terminals 1-1 to 1-5 has a unique node ID (IDentifier) and an IP (Internet Protocol) address. Since the IP addresses assigned to the terminals 1-1 to 1-5 are not duplicate, the IP address may be employed as the node ID.

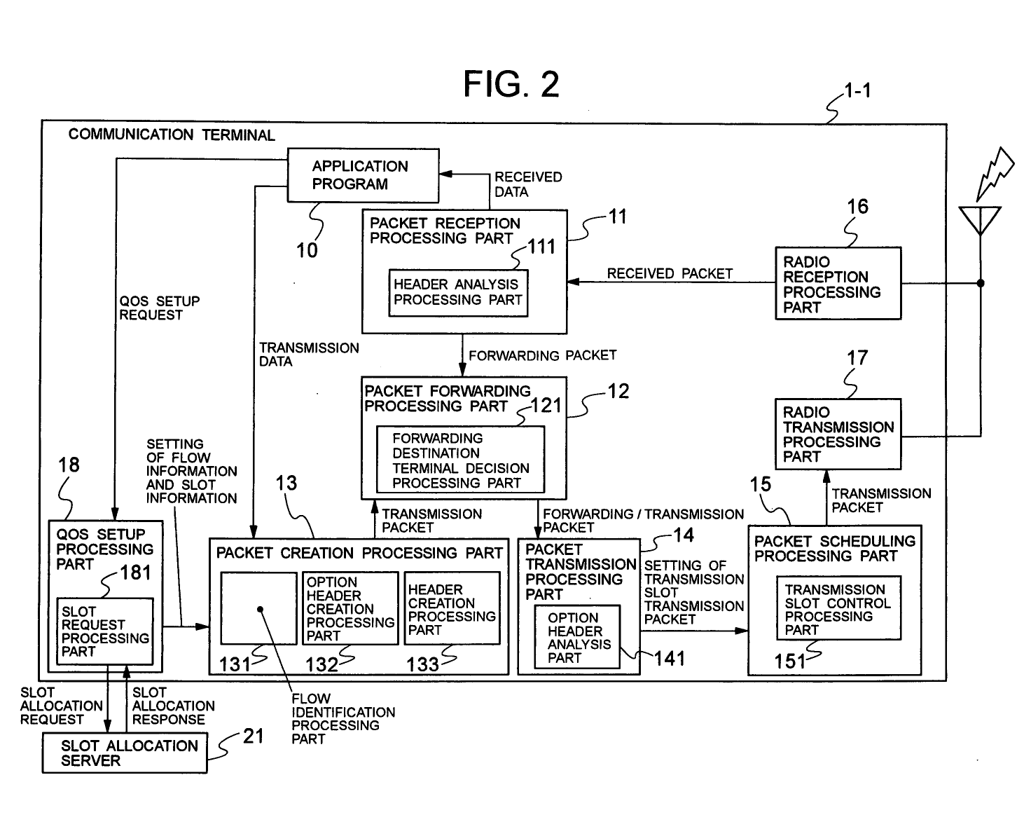

FIG. 2 is a block diagram showing the functional configuration of the terminals 1-1 to 1-5 according to the first embodiment of the invention. In FIG. 2, the terminal 1-1 comprises an application program (hereinafter referred to as an application) 10, a packet reception processing part 11, a packet forwarding processing part 12, a packet creation processing part 13, a packet transmission processing part 14, a packet scheduling processing part 15, a radio reception processing part 16, a radio transmission processing part 17, and a QoS (Quality of Service) setup processing part 18.

Also, the packet reception processing part 11 comprises a header analysis processing part 111, the packet forwarding processing part 12 comprises a forwarding destination terminal decision processing part 121, and the packet creation processing part 13 comprises a flow identification processing part 131, an option header creation processing part 132 and a header creation processing part 133. The packet transmission processing part 14 comprises an option header analysis part 141, the packet scheduling processing part 15 comprises a transmission slot control processing part 151, and the QoS setup processing part 18 comprises a slot request processing part 181. The other terminals 1-2 to 1-5 have the same configuration as the terminal 1-1.

If the terminal 1-1 makes a slot request based on a QoS setup request from the application 10, the slot request processing part 181 registers the flow information of the application (information consisting of the destination terminal and the information (port number, etc.) specifying the application) in the flow identification processing part 131.

The flow identification processing part 131 identifies whether or not the transmit data created by the application 10 is the QoS set flow, and the option header creation processing part 132 creates an option header storing the reserved slot information, if the transmit data is the QoS set flow. The header creation processing part 133 creates the entire header including the option header.

The forwarding destination terminal decision processing part 121 decides a forwarding destination terminal, based on the header information of the transmission packet created by the packet creation processing part 13 or the forwarding packet received from the packet reception processing part 11. The option header analysis part 141 analyzes the option header of the transmission packet or the forwarding packet, and sets the time slot for transmitting the packet to the packet scheduling processing part 15. The transmission slot control processing part 151 makes a scheduling control to transmit the packet in the set time slot.

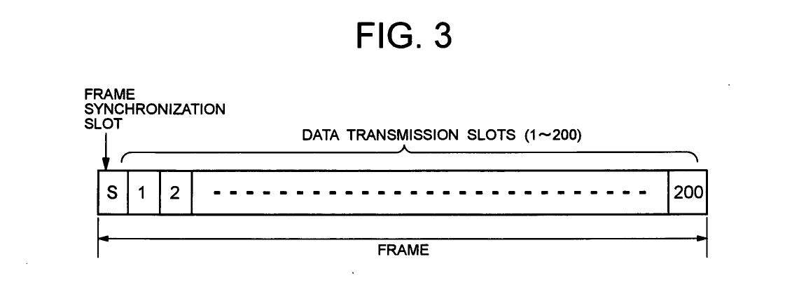

FIG. 3 shows the structure of a TDMA frame for use in the first embodiment of the invention. In FIG. 3, one TDMA frame is composed of a frame synchronization slot (S) and the data transmission slots (1 to 200). In this embodiment, the following explanation is based on the precondition that one TDMA frame consists of 200 slots.

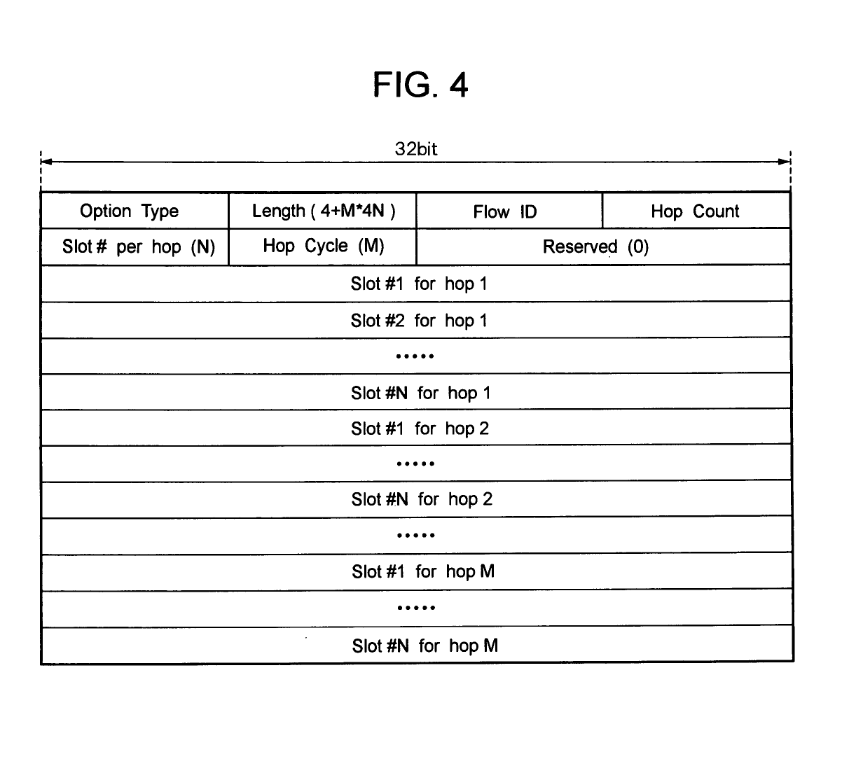

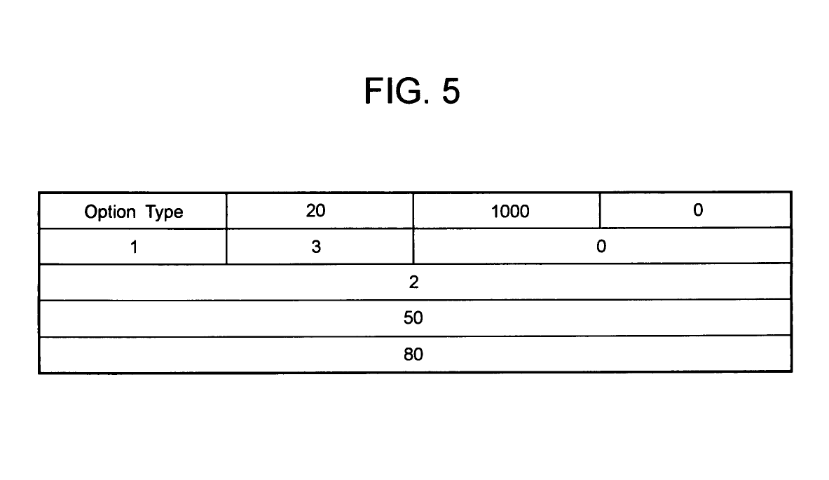

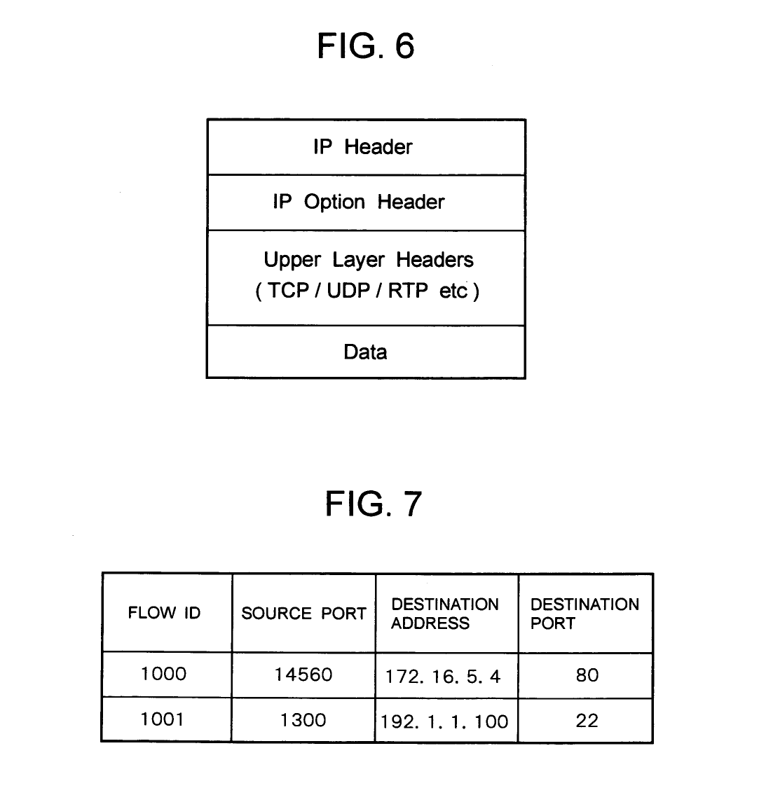

FIG. 4 shows the structure of an option header created in the first embodiment of the invention. FIG. 5 shows the organization of the option header passed to the header creation processing part 133 of FIG. 2. FIG. 6 shows the structure of a transmission packet created in the first embodiment of the invention.

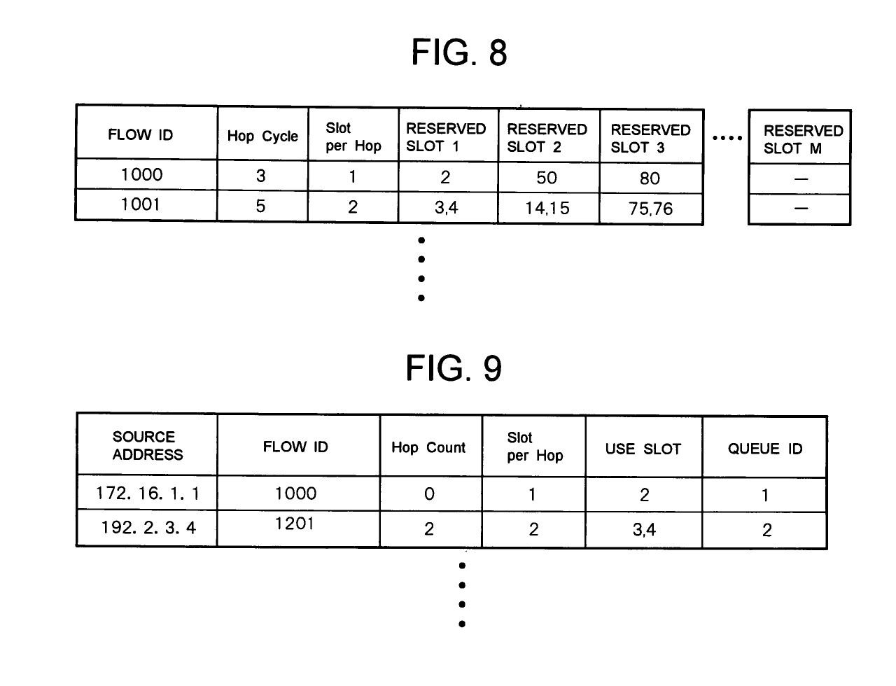

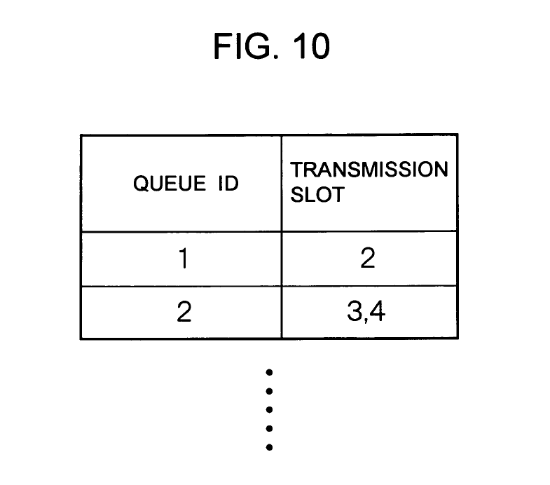

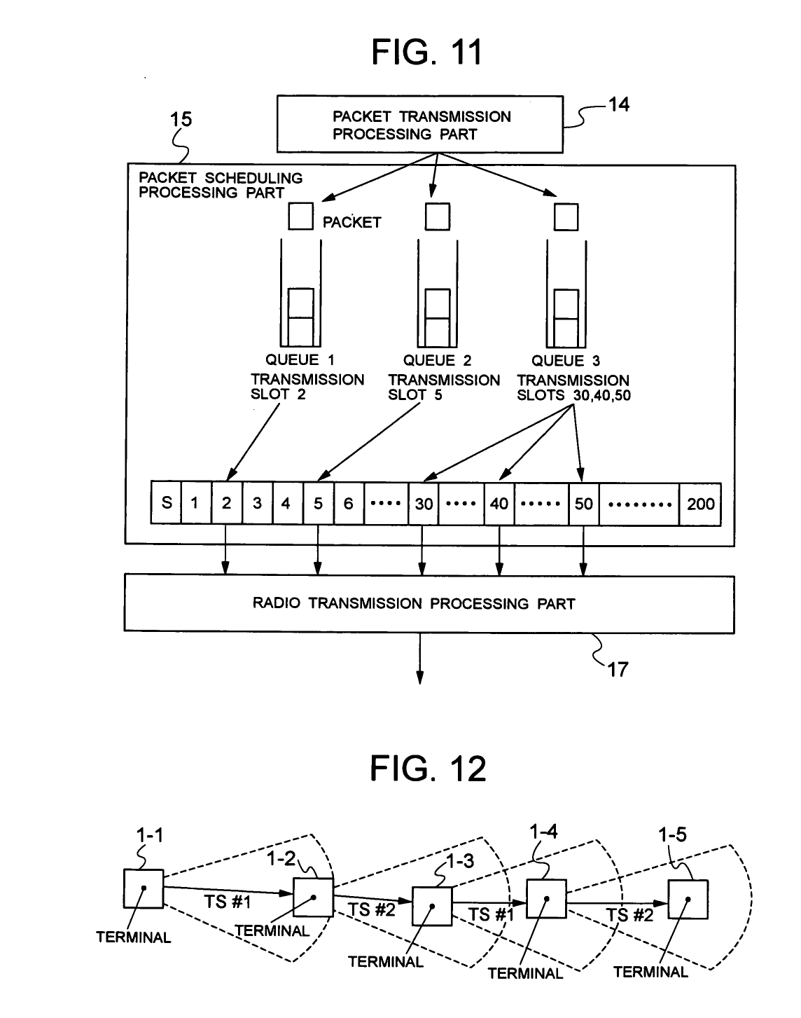

FIG. 7 shows a flow table held in the flow identification processing part 131 of FIG. 2. FIG. 8 shows a slot information table held in the option header creation processing part 132 of FIG. 2. FIG. 9 shows the structure of a flow cache table in the first embodiment of the invention. FIG. 10 shows the structure of a cache table in the first embodiment of the invention. FIG. 11 is a diagram schematically showing a scheduling operation in the first embodiment of the invention.

In FIG. 4, the option header is added in front of “Slot #1 for hop 1” to “Slot #N for hop M”, and includes “Option Type”, “Length(4+M*4N)”, “Flow ID”, “Hop Count”, “Slot# per hop(N)”, “Hop Cycle(M)” and “Reserved(0)”.

In FIG. 5, the option header is added in front of “Slot #1 for hop 1”=2, “Slot #1 for hop 2”=50 and “Slot #1 for hop 3”1=80, and includes “Option Type”, “Length(4+M*4N)”=20, “Flow ID”=1000, “Hop Count”=0, “Slot# per hop(N)”=1, “Hop Cycle(M)”=3 and “Reserved(0)”=0.

In FIG. 6, the transmission packet is composed of “IPHeader”, “IP Option Header”, “Upper Layer Headers (TCP/UDP/RTP etc.) and “Data”.

In FIG. 7, the flow table is provided with the entries of the “flow ID” (‘1000’, ‘1001’, . . . ), the “source port” (‘14560’, ‘1300’, . . . ), the “destination address” (‘172.16.5.4’, ‘192.1.1.100’, . . . ) and the “destination port” (‘80’, ‘22’, . . . ).

In FIG. 8, the slot information table is provided with the entries of the “flow ID” (‘1000’, ‘1001’, . . . ), the “Hop Cycle” (‘3’, ‘5’, . . . ), the “Slot per Hop” (‘1’, ‘2’, . . . ), the “reserved slot1” (‘2’, ‘3,4’, . . . ), the “reservedslot2” (‘50’, ‘14,15’, . . . ), the “reserved slot 3” (‘80’, ‘75, 76’, . . . ) and the “reserved slot M” (‘-’, ‘-’, . . . )

In FIG. 9, the flow cache table is provided with the entries of the “source address” (‘172.16.1.1’, ‘192.2.3.4’, . . . ), the “flow ID” (‘1000’, ‘1201’, . . . ), the “Hop Count” (‘0’, ‘2’, . . . ), the “Slot per Hop” (‘1’, ‘2’, . . . ), the “use slot” (‘2’, ‘3, 4’’ . . . ), and the “queue ID” (‘1’, ‘2’, . . . ).

In FIG. 10, the cache table is provided with the entries of the “queue ID” (‘1’, ‘2’, . . . ) and the “transmission slot” (‘2’, ‘3, 4’, . . . ).

Referring to FIGS. 1 to 11, the operation of the wireless multi-hop network according to the first embodiment of the invention will be described below.

First of all, (1) the transmission of a packet will be described below. When the application 10 operating at the terminal 1-1 performs the bandwidth ensured communication with the application at the terminal 1-5, the application 10 at the terminal 1-1 firstly makes a QoS setup request to the QoS setup processing part 18. The QoS setup processing part 18 transmits a slot allocation request to reserve the bandwidth demanded by the application 10 to the slot allocation server 21.

The slot allocation server 21 manages all the TDMA time slots for data channel in the wireless multi-hop network and makes the required slot allocation in accordance with the slot allocation request. The slot allocation is performed so that the slot allocated to each terminal maybe unique within the network. That is, the slot allocated to the terminal 1-1 can be used in only the flow originated from the terminal 1-1. The slot allocation server 21 transmits an allocation response to the terminal 1-1 to allocate M times the slots as requested by the application 10 (e.g., (10*M)Kbps for the request of 10 Kbps) to the terminal 1-1.

If the allocation of slot is successful, the QoS setup processing part 18 sets the flow information for communicating the packet of the application in the allocated slot to the flow identification processing part 131. The flow information comprises the source IP address, the destination IP address, the source port number and the destination port number. If a new flow is registered, the flow identification processing part 131 assigns an identifier (flow ID) to the flow. The flow table held in the flow identification processing part 131 is shown in FIG. 7.

If the flow identification processing part 131 assigns the flow ID, it registers the flow information and the slot information reserved on the flow in the option header creation processing part 132. The slot information table held in the option header creation processing part 132 is shown in FIG. 8. In FIG. 8, the “Slot per Hop” is the number of slots required for forwarding the packet in one hop, and the “Hop CYCLE” is the cycle of the number of hops for reusing the slot. In the following explanation, for the simplification, it is supposed that the “Slot per Hop”=1 (capable of forwarding the packet in one slot) and the “HopCYCLE”=3 (reusing the slot at every three hops).

The “Slot per Hop” is the value returned with a slot allocation response from the slot allocation server 21, which computes the required number of slots based on bandwidth information included in the slot allocation request from the QoS setup processing part 18. The “Hop CYCLE” is the information computed by the QoS setup processing part 18 and incorporated into the slot allocation request. Usually, the “Hop CYCLE” is 3, but this value may be changed, depending on a collision occurring during the packet forwarding or the use of a directional antenna (as will be described later in detail). In this embodiment, it is supposed that the slots allocated from the slot allocation server 21 are No. 2, No. 50 and No. 8 , the flow ID of the application 10 of the terminal 1-1 is No. 1000.

If the QoS setup request is successful, the application 10 of the terminal 1-1 starts to transmit data. The data transmitted from the application 10 is passed to the packet creation processing part 13. The flow identification processing part 131 of the packet creation processing part 13 identifies that this data is subject to the QoS reservation and passes it to the option header creation processing part 132. The option header creation processing part 132 creates the option header (IP option header in the case of IP communication) as shown in FIG. 4, based on the slot information reserved for the flow, and passes it to the header creation processing part 133. In this case, the option header has the structure as shown in FIG. 5.

The header creation processing part 133 creates the upper level layer headers (TCP (Transmission Control Protocol), UDP (User Datagram Protocol), RTP (Real Time transport Protocol), etc.) and the IP header, and creates a transmission packet by merging them with the option header and the data. The structure of the created transmission packet is shown in FIG. 6.

There are two or more methods for representing the slot number, in addition to indicating it separately as shown in FIG. 4. One method involves defining beforehand a block consisting of a plurality of slots, and describing its block number. Another method involves making the slot number hierarchical and cycling the lower M bits with the upper N bits fixed. Employing these slot representation methods, the information put into the option header can be reduced.

Also, it is possible to describe a plurality of slot sets, and specify which number slot set is employed from the terminal at the Nth hop. Further, it is possible to specify that the particular terminal employs the slot designated within the option header.

The packet creation processing part 13 passes the transmission packet to the packet forwarding processing part 12. The packet forwarding processing part 12 searches an IP route table from the destination address of the IP header, and decides the next hop to forward the packet. If the next hop is decided, the packet is passed to the packet transmission processing part 14. The IP route table is preset in accordance with the routing protocol, and successively updated.

The option header analysis part 141 of the packet transmission processing part 14 confirms the presence or absence of the IP option header, and analyzes the content, if any. Specifically, a “Hop Count” field and a “Hop CYCLE” field of the option header are referred to. If their values are C and U, the “C mod U” is computed. The packet transmission processing part 14 decides which slot is employed to transmit this packet, based on its result.

When the terminal 1-1 transmits the packet, the “C mod U” is equal to 0, because C is equal to 0 and U is equal to 3. If the “C mod U” is equal to 0, a transmission slot setup request to transmit the packet employing the “Slot for Hop 1” (2 in this case) is issued to the transmission slot control processing part 151, the value of the “Hop Count” field of the option header is rewritten by adding 1 to it, and the packet is passed to the packet scheduling processing part 15.

The packet scheduling processing part 15 transmits the packet to the terminal 1-2 of the next hop, employing the set slot No. 2. The packet scheduling processing part 15 manages packets received from the packet transmission processing part 14 in terms of queue for each flow, and transmits the packets. The outline of the scheduling operation is shown in FIG. 11.

The option header analysis part 141 may have a flow cache table to speed up the analysis from the second time. The organization of the flow cache table is shown in FIG. 9. The flow cache table records the source IP address, the flow ID, the HOP Count, the Slot per Hop, and the use slot number for a packet.

When a packet in the same flow is received, the option header analysis part 141 decides that the slot recorded in the table (not shown) is employed without making the above computation, if the source IP address, the flow ID and the “Hop Count” are identical to those in the table. Further, the packet scheduling processing part 15 may have a cache table as shown in FIG. 10, whereby the packet hit in the flow cache table of the option header analysis part 141, can dispense with a transmission slot setup request to the transmission slot control processing part 151.

Subsequently, (2) the forwarding of packet will be described below. In the terminal 1-2 receiving a packet from the terminal 1-1, the packet is input to the packet reception processing part 11. The packet reception processing part 11 confirms that the destination IP address of the IP header is not the address of the terminal 1-2, and passes the packet to the packet forwarding processing part 12. The packet forwarding processing part 12 decides the next hop to forward the packet at the next time from the IP route table, and passes the packet to the packet transmission processing part 14.

The packet transmission processing part 14 confirms the presence or absence of the IP option header, and analyzes the content of the IP option header in the same way as in the above case (1), if any. Because C is equal to 1 and U is equal to 3, the “C mod U” is equal to 1. If the “C mod U” is equal to 1, a transmission slot setup request to transmit the packet employing the “Slot for Hop 2” (50 in this case) is issued to the transmission slot control processing part 151, the value of the “Hop Count” field of the option header is rewritten by adding 1 to it, and the packet is passed to the packet scheduling processing part 15. The packet scheduling processing part 15 transmits the packet to the terminal 1-3 of the next hop, employing the set slot No. 50.

In the same way, packets are forwarded from the terminal 1-3 to the terminal 1-4 by employing the slot No. 80, and from the terminal 1-4 to the terminal 1-5 by employing the slot No. 2.

Herein, if the radio transmission range of each terminal is identical, time slots are re-used by the nodes separated two hops or more. As shown in FIG. 1, when the terminal 1-1 transmits the packet to the terminal 1-2 by employing slot No. 2, the terminal 1-2 can not employ the slot No. 2. Further, the terminal 1-3 can not transmit the packet to the terminal 1-4 by employing the slot No. 2. Because the radio wave of the terminal 1-3 reaches the terminal 1-2, the terminal 1-2 receives the radio wave from the terminal 1-1 and the radio wave from the terminal 1-3 in the slot No. 2 at the same time, and can not normally receive the packet from the terminal 1-1. The terminal 1-4 can transmit the packet to the terminal 1-5 by reusing the slot No. 2.

Thus, in this embodiment, the utilization efficiency of the slot can be increased by reusing the slot for every three hops. This is the reason that the “Hop CYCLE” is 3.

Next, (3) the reception of the packet will be described below. The radio reception processing part 16 at the terminal 1-5 receiving the packet from the terminal 1-4 passes the packet to the packet reception processing part 11. The packet reception processing part 11 passes the received data to the application 10 because the destination IP address of the IP header is the address of the terminal 1-4. In this explanation, the description for the process for the upper level layers such as TCP, RTP and UDP is omitted.

In this way, in this embodiment, the multi-hop communication with the bandwidth ensured can be performed between the terminal 1-1 and the terminal 1-5 employing the secured slot through the above processes (1) to (3).

As described above, the bandwidth ensured communication method according to the first embodiment of the invention can solve the above-mentioned problems. First of all, in the bandwidth ensured communication method according to the first embodiment of the invention, since the unique slot within the network is allocated by the slot allocation server 21, there is no interference with the slot by other terminals. Also, in the bandwidth ensured communication method according to the first embodiment of the invention, since the forwarding terminal decides the slot based on the option header information at the time of forwarding, it is unnecessary that each terminal making up the path reserves a slot again as in the conventional slot reservation method, even if the route of the path changes because of the movement of forwarding terminals.

Hence, with the bandwidth ensured communication method according to the first embodiment of the invention, the stable end-to-end bandwidth ensured communication in the wireless multi-hop network is allowed, though it could not be achieved by the conventional bandwidth ensured communication method.

In the first embodiment of the invention as described above, the “Hop CYCLE” (cycle of the number of hops for reusing the slot) is usually 3 for the above reason, but this value may be made 2 by employing a directional antenna.

FIG. 12 is a diagram showing a forwarding example of packet according to a second embodiment of the invention, and shows the forwarding example of packet which involves reusing two slots in the case where the directional antenna is employed. In the forwarding example as shown in FIG. 12, since the radio wave transmitted by the terminal 1-3 does not reach the terminal 1-2, the slot can be reused at a cycle of two hops.

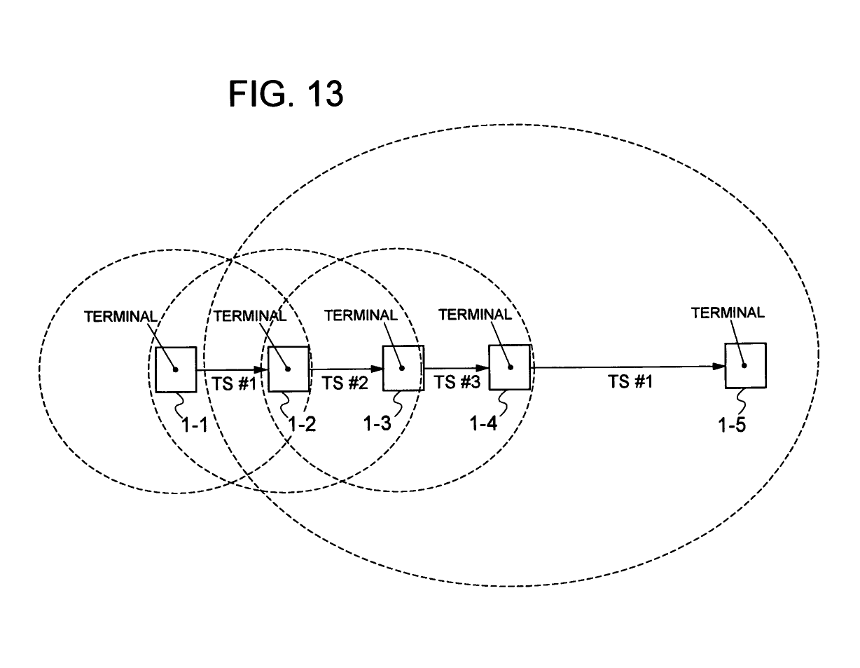

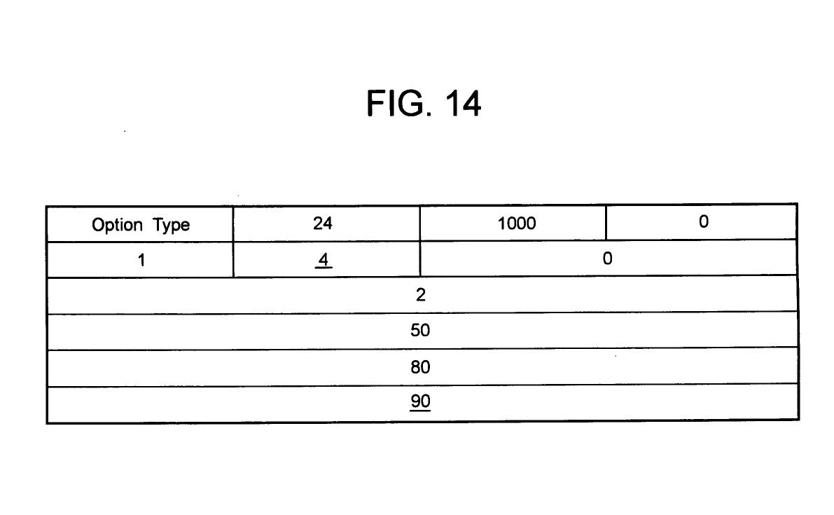

FIG. 13 is a diagram showing a transmission interference example according to a third embodiment of the invention. FIG. 14 shows an option header example with increased “Hop CYCLE” in the third embodiment of the invention. In FIG. 13, the radio wave transmission outputs are different for the terminals 1-1 to 1-5, and particularly, the output of the terminal 1-4 is so great that the radio wave can reach the terminal 1-2. In this case, if the terminal 1-4 reuses the slot No. 1, the radio wave from the terminal 1-4 interferes with the transmission from the terminal 1-1 to the terminal 1-2, so that a reception error frequently occurs at the terminal 1-2, disabling the stable communication to be made.

In this way, if a reception error frequently occurs at the certain terminal, the situation may be mitigated by increasing the “Hop CYCLE”. For example, if the “Hop CYCLE” is 4 and four slots are employed, the transmission interference between the terminal 1-1 and the terminal 1-4 in FIG. 13 can be resolved.

Thus, if an error frequently occurs in the secured slot in the bandwidth ensured communication (flow of the packet with option head in the invention), the terminal 1-2 issues a slot reallocation request to the terminal 1-1 that is the transmitter (source) of flow, employing the control channel. The terminal 1-1 receiving the slot reallocation request makes a QoS setup request again by increasing the “Hop CYCLE”, and is newly allocated the additional slot by the slot allocation server 21.

If the slot reallocation is completed, the terminal 1-1 transmits a packet having the option header with the increased “Hop CYCLE”, as shown in FIG. 14. If more slots are allocated beforehand at the start of communication, a procedure for transmitting a slot allocation request to the slot allocation sever 21 after receiving the slot reallocation request from the terminal 1-2 can be omitted, and the “Hop Cycle” can be increased.

Also, the routing protocol as described in T. Clause and one other, “Optimized Link State Routing Protocol (OLSR)”, IETF RFC 3626, October 2003 is extended to advertise the unidirectional link, whereby the source terminal confirms the terminal existing on the path to the destination terminal at the time of QoS setup, and if the unidirectional link exists and a portion where there is slot interference is found, it is possible to make a slot allocation request by computing beforehand the “HopCYCLE” without interference.

In FIG. 13, the terminal 1-2 has the unidirectional link to the terminal 1-4. If it is found that the terminal 1-4 is at the number of hops using the slot for the terminal 1-2 to receive on the communication path of the terminals 1-1 to 1-5, the “Hop CYCLE” is set to 4 to make a slot request, whereby the communication is made with “Hop CYCLE”=4. Thereby, if it is known beforehand that the interference occurs with the “Hop CYCLE”=3, it can be avoided at the time of QoS setup.

Also, the source terminal may investigate the number of slots without interference for all the terminals on the path to the destination terminal before starting the communication, whereby the required number of slots can be known beforehand, even if the unidirectional link information is not advertised in accordance with the routing protocol.

One of the reasons for frequent reception error in the reserved slot at the forwarding terminal may be a change in the interference range or a change in the topology when each terminal moves, besides the above case. A distinction from the third embodiment of the invention is made by judging whether or not the terminal 1-2 has the unidirectional link to the terminal 1-4 in the case as shown in FIG. 14 (the unidirectional link can be treated as Asymmetric Neighbor in T. Clause and one other, “Optimized Link State Routing Protocol (OLSR)”, IETF RFC 3626, October 2003, for example).

In this case, the communication path can be updated to solve the reception error by making a trigger of transmitting a control message to the routing protocol to prompt the route update.

Also, the number of slots without interference is estimated in consideration of a distribution situation for other terminals obtained from the routing protocol or interference frequency in the communication so far, and the number of slots estimated at the start of communication may be reserved. When this estimation can not be made in the above way, the predetermined number of slots may be reserved.

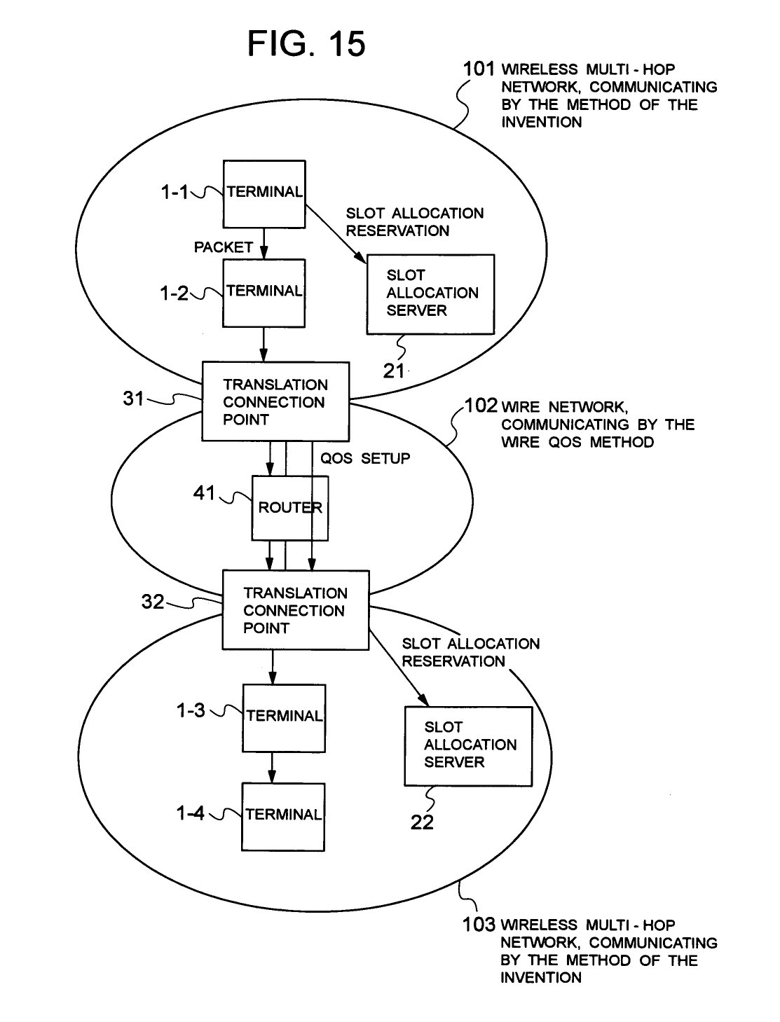

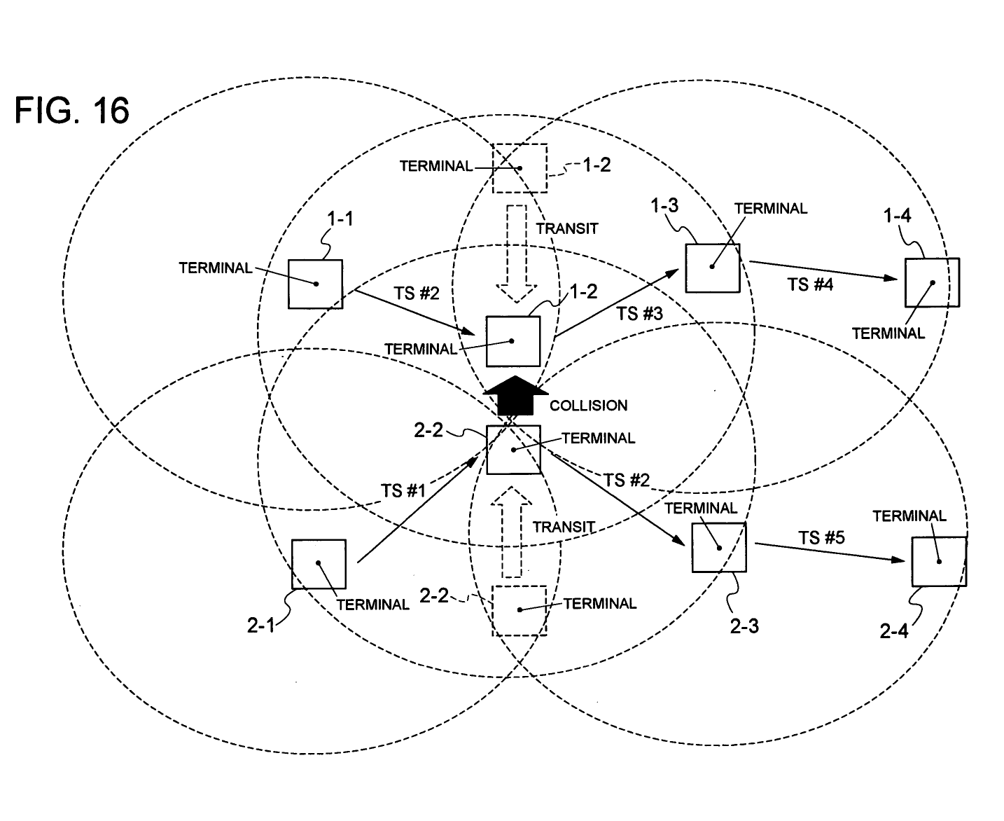

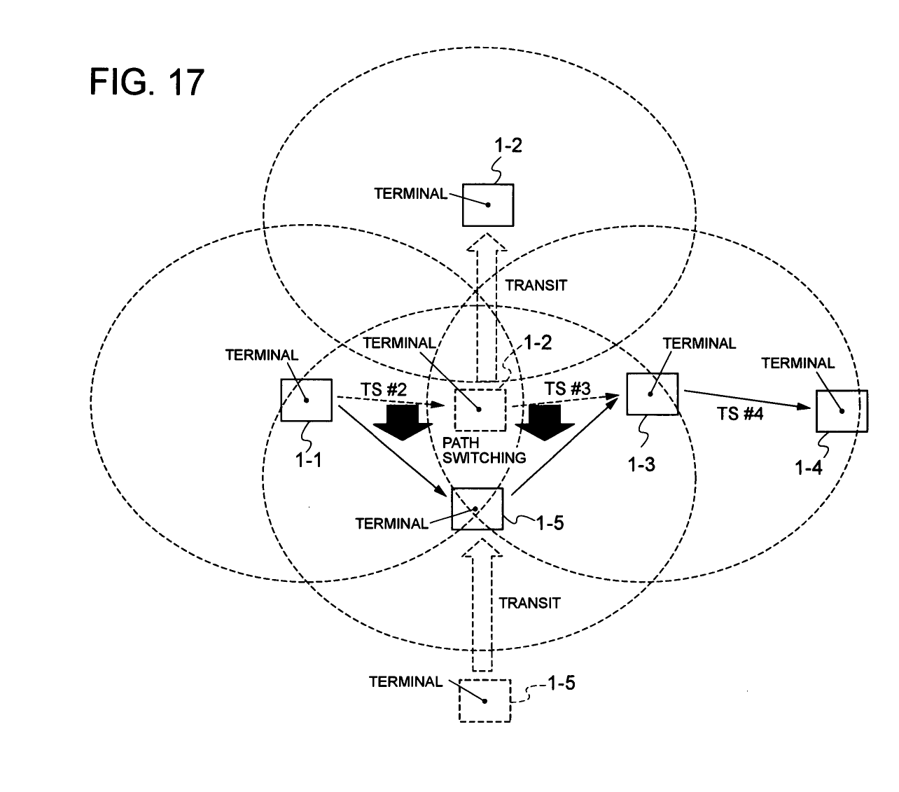

FIG. 15 shows a bandwidth ensured communication method according to a fourth embodiment of the invention. In FIG. 15, there is an environment where a wire network 102 and wireless multi-hop networks 101 and 103 are mixed. The wire network 102 and the wireless multi-hop networks 101 and 103 are connected at translation connection points 31 and 32. The wireless multi-hop network 101 comprises terminals 1-1 and 1-2 and a slot allocation server 21, the wire network 102 comprises a router 41, and the wireless multi-hop network 103 comprises terminals 1-3 and 1-4 and a slot allocation server 22.

In the environment where the wire network and the wireless network are mixed as shown in FIG. 15, the bandwidth reservation in the wire network is made, based on the slot information of the option header at the translation connection point 31 from the wireless network to the wire network, and conversely, the slot in the wireless network is reserved, based on the bandwidth reservation information of the wire network at the translation connection point 32 from the wire network to the wireless network.

Thereby, in this embodiment, the end-to-end bandwidth ensured communication can be made not only within the wireless multi-hop network, but also in the environment where the wireless network and the wire network are mixed.

While in the above first to fourth embodiments of the invention, the TDMA is presupposed as the radio control method, and the resource required for the bandwidth reservation is the time slot, the code may be the resource in the wireless network controlled by the CDMA (Code Division Multiple Access) method to apply the bandwidth ensured communication method of the invention in the same way.

What is claimed is:

1. A wireless multi-hop network comprising a plurality of terminals making the transmission, reception and forwarding of a packet by radio, wherein a source terminal transmits the packet by inserting reserved resource information into a header of the packet.

2. The wireless multi-hop network according to claim 1, wherein a forwarding terminal decides a resource that the forwarding terminal can use to forward packets, based on the information in the packet header, and forwards the packet using the resource designated in the header.

3. The wireless multi-hop network according to claim 2, wherein the forwarding terminal makes a notification of a failure to the source terminal, when the communication fails in the designated resource, and the source terminal readjusts the resource reservation when receiving the notification.

4. The wireless multi-hop network according to claim 2, wherein the forwarding terminal issues a trigger of updating the forwarding path of the packet to a routing protocol, when the communication fails in the designated resource.

5. The wireless multi-hop network according to claim 4, wherein the source terminal computes the required resource prior to the start of communication using the information obtained from the routing protocol.

6. A terminal in a wireless multi-hop network comprising a plurality of terminals making the transmission, reception and forwarding of a packet by radio, the terminal comprising means for transmitting the packet by inserting a reserved resource information into a header of the packet at the time of transmitting the packet.

7. The terminal according to claim 6, further comprising means for deciding a resource that the terminal can use to forward packets, based on the information in the packet header at the time of forwarding the packet, and means for forwarding the packet using the decided resource.

8. The terminal according to claim 7, further comprising means for making a notification of a failure to a source terminal that transmits the packet, when the communication fails in the reserved resource at the time of forwarding the packet, and means for readjusting the resource reservation when receiving the notification of a failure from a forwarding terminal that forwards the packet in transmitting the packet.

9. The terminal according to claim 7, further comprising means for issuing a trigger of updating the forwarding path of the packet to a routing protocol, when the communication fails in the reserved resource at the time of forwarding the packet.

10. The terminal according to claim 9, further comprising means for computing the required resource prior to the start of communication using the information obtained from the routing protocol at the time of transmitting the packet.

11. A bandwidth ensured communication method for use in a wireless multi-hop network comprising a plurality of terminals making the transmission, reception and forwarding of a packet by radio, wherein the terminal performs a process of transmitting the packet by inserting a reserved resource information into a header of the packet at the time of transmitting the packet.

12. The bandwidth ensured communication method according to claim 11, wherein the terminal performs a process of deciding a resource that the terminal can use to forward packets, based on the information in the packet header at the time of forwarding the packet, and a process of forwarding the packet using the decided resource.

13. The bandwidth ensured communication method according to claim 12, wherein the terminal performs a process of making a notification of a failure to a source terminal that transmits the packet, when the communication fails in the reserved resource at the time of forwarding the packet, and a process of readjusting the resource reservation when receiving the notification of a failure from a forwarding terminal that forwards the packet in transmitting the packet.

14. The bandwidth ensured communication method according to claim 12, wherein the terminal performs a process of issuing a trigger of updating the forwarding path of the packet to a routing protocol, when the communication fails in the reserved resource at the time of forwarding the packet.

15. The bandwidth ensured communication method according to claim 14, wherein the terminal performs a process of computing the required resource prior to the start of communication using the information obtained from the routing protocol at the time of transmitting the packet.
